(19) United States
(12) Patent Application Publication
(10) Pub. No.: US 2026/0145912 A1
(43) Pub. Date: May 28, 2026

(54) FULL-CEILING DROP-DOWN PLATFORMS FOR MAINTENANCE FROM INSIDE CA

(71) Applicant: Otis Elevator Company, Farmington, CT (US)

(72) Inventors: Ergün Alkan, Schönefeld (DE); Thomas Masayda, Watertown, CT (US)

(21) Appl. No.: 18/956,767

(22) Filed: Nov. 22, 2024

(51) Int. Cl. B66B 11/02

(52) U.S. Cl. CPC B66B 11/0246

(57) ABSTRACT

An elevator car is provided and includes a body and an actuation system. The body includes a floor, sidewalls and a ceiling movable relative to the sidewalls. The actuation system is coupled with the ceiling and operable to raise and lower the ceiling.

### BACKGROUND

The present disclosure relates to elevator systems and, in particular, to an elevator system with full-ceiling drop-down platforms for maintenance from inside car.

In an elevator system, in particular, an elevator shaft is built into a building and an elevator car travels up and down along the elevator shaft to arrive at landing doors of different floors of the building. The movement of the elevator is driven by a machine that is controlled by a controller according to instructions received from users of the elevator system. During operational conditions, passengers will typically arrive at an elevator landing in a building, request an elevator and wait for the elevator to arrive. Once the elevator arrives and its doors open, the passenger will enter the elevator and select a destination floor. The doors close and the elevator travels upwardly or downwardly to the selected floor whereupon the passenger disembarks.

### SUMMARY

According to an aspect of the disclosure, an elevator car is provided and includes a body and an actuation system. The body includes a floor, sidewalls and a ceiling movable relative to the sidewalls. The actuation system is coupled with the ceiling and operable to raise and lower the ceiling.

In accordance with one or more additional and/or alternative embodiments, the actuation system includes one of a winch including a spool and a cable, which is woundable on the spool and attached to the ceiling, the spool being operable to raise and lower the ceiling by winding and unwinding the cable and an actuator which is operable to move between first and second positions associated with raised and lowered positions of the ceiling, respectively, and a cable extending from the actuator and to the ceiling whereby the ceiling is raised and lowered as the actuator moves between the first and second positions.

According to an aspect of the disclosure, an elevator car is provided and includes a body and a winch. The body includes a floor, sidewalls and a ceiling movable relative to the sidewalls. The winch includes a spool and a cable, which is woundable on the spool and attached to the ceiling. The spool is operable to raise and lower the ceiling by winding and unwinding the cable.

In accordance with one or more additional and/or alternative embodiments, the elevator car further includes a brace about which the cable extends between the spool and the ceiling.

In accordance with one or more additional and/or alternative embodiments, the brace is disposable across a middle of the ceiling and movable to a side of the body.

In accordance with one or more additional and/or alternative embodiments, the ceiling includes an open-sided guard disposable about a connection point between the cable and the ceiling.

In accordance with one or more additional and/or alternative embodiments, the spool is formed to define an opening into which a tool for operating the spool is insertable.

In accordance with one or more additional and/or alternative embodiments, the sidewalls are formed to define guide grooves for guiding a raising and a lowering of the ceiling.

In accordance with one or more additional and/or alternative embodiments, the elevator car further includes handrails attached to the sidewalls and platforms disposable on the handrails to support the ceiling at a lowest point.

In accordance with one or more additional and/or alternative embodiments, the elevator car further includes a foldable support.

In accordance with one or more additional and/or alternative embodiments, the ceiling includes electronics and the elevator car further includes wiring with slack by which the electronics are electrically connectable with a power source.

According to an aspect of the disclosure, an elevator car is provided and includes a body, an actuator and a cable. The body includes a floor, sidewalls and a ceiling movable relative to the sidewalls. The actuator is operable to move between first and second positions associated with raised and lowered positions of the ceiling, respectively. The cable extends from the actuator and to the ceiling whereby the ceiling is raised and lowered as the actuator moves between the first and second positions.

In accordance with one or more additional and/or alternative embodiments, the actuator and the cable are provided in pairs thereof on opposite sides of the body.

In accordance with one or more additional and/or alternative embodiments, the actuator is one of movable vertically or horizontally along an exterior of one of the sidewalls and movable vertically or horizontally through an interior of one of the sidewalls.

In accordance with one or more additional and/or alternative embodiments, the actuator includes a linear actuator.

In accordance with one or more additional and/or alternative embodiments, the elevator car includes a track along which the actuator is movable.

In accordance with one or more additional and/or alternative embodiments, the ceiling includes an open-sided guard disposable about a connection point between the cable and the ceiling.

In accordance with one or more additional and/or alternative embodiments, the elevator car further includes handrails attached to the sidewalls and platforms disposable on the handrails to support the ceiling at a lowest point.

In accordance with one or more additional and/or alternative embodiments, the elevator car further includes a foldable support.

In accordance with one or more additional and/or alternative embodiments, the ceiling includes electronics and the elevator car further includes wiring with slack by which the electronics are electrically connectable with a power source.

Additional features and advantages are realized through the techniques of the present disclosure. Other embodiments and aspects of the disclosure are described in detail herein and are considered a part of the claimed technical concept. For a better understanding of the disclosure with the advantages and the features, refer to the description and to the drawings.

### BRIEF DESCRIPTION OF THE DRAWINGS

For a more complete understanding of this disclosure, reference is now made to the following brief description, taken in connection with the accompanying drawings and detailed description, wherein like reference numerals represent like parts:

FIG. 1 is a perspective view of an elevator system in accordance with embodiments;

FIGS. 2A, 2B and 2C are perspective views of an elevator car with a movable ceiling in accordance with embodiments;

FIGS. 3A and 3B are side views of an elevator car with a movable ceiling and a winch to raise and lower the movable ceiling in accordance with embodiments;

FIG. 4 is an enlarged perspective view of the dashed box 4-4 of FIG. 2B showing an open-sided guard to provide for attachment and detachment of a cable to a ceiling of an elevator car in accordance with embodiments;

FIG. 5 is an enlarged perspective view of the dashed box 5-5 of FIG. 2B showing a handrail and a platform to support a ceiling of an elevator car in a lowered position in accordance with embodiments;

FIG. 6 is an enlarged perspective view of the dashed box 5-5 of FIG. 2B showing a foldable support to support a ceiling of an elevator car in a lowered position in accordance with embodiments;

FIGS. 7A and 7B are side views of an elevator car with a movable ceiling and an actuator to raise and lower the movable ceiling in accordance with embodiments;

FIG. 8 is a side schematic view of an actuator that moves horizontally along a sidewall exterior in accordance with embodiments;

FIGS. 9A and 9B are side schematic views of an actuator that moves vertically and horizontally along a sidewall exterior in accordance with embodiments.

### DETAILED DESCRIPTION

In elevator systems, maintenance from inside car concepts provide for access to hoistway components through a ceiling of an elevator car of an elevator system. This is typically accomplished by way of transforming a foldable decorative ceiling into a working platform or by pivoting a decorative ceiling to create room for a working platform that is stowed on or above the decorative ceiling and then deploying the working ceiling. In any case, conventional maintenance from inside car concepts are, however, not always scalable or cost effective.

Thus, as will be described below, a maintenance from inside car design is provided in a simplified configuration. The maintenance from inside car design uses the car roof as a working platform along with full-ceiling drop-down solutions with which no additional platform is needed, no partial openings in the ceiling structure are needed and no costly designs with hinges and rotating parts are needed to deploy the platform. The maintenance from inside car design can include embodiments in which the ceiling becomes the working platform when lowered with a winch and/or with linear actuators.

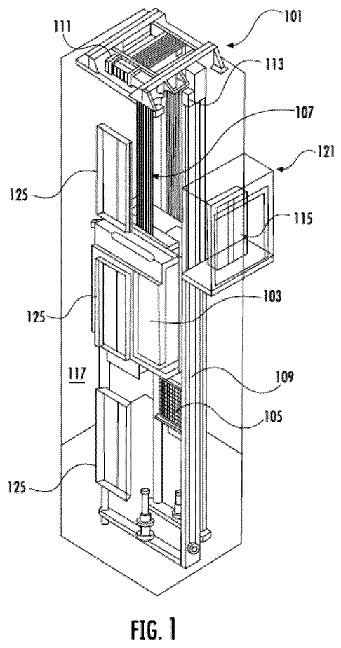

With reference to FIG. 1, which is a perspective view of an elevator system 101, the elevator system 101 includes an elevator car 103, a counterweight 105, a tension member 107, a guide rail 109, a machine 111, a position reference system 113 and a controller 115. The elevator car 103 and the counterweight 105 are connected to each other by the tension member 107. The tension member 107 may include or be configured as, for example, ropes, steel cables and/or coated-steel belts. The counterweight 105 is configured to balance a load of the elevator car 103 and is configured to facilitate movement of the elevator car 103 concurrently and in an opposite direction with respect to the counterweight 105 within an elevator shaft 117 and along the guide rail 109.

The tension member 107 engages the machine 111, which is part of an overhead structure of the elevator system 101. The machine 111 is configured to control movement between the elevator car 103 and the counterweight 105. The position reference system 113 may be mounted on a fixed part at the top of the elevator shaft 117, such as on a support or guide rail, and may be configured to provide position signals related to a position of the elevator car 103 within the elevator shaft 117. In other embodiments, the position reference system 113 may be directly mounted to a moving component of the machine 111, or may be located in other positions and/or configurations as known in the art. The position reference system 113 can be any device or mechanism for monitoring a position of an elevator car and/or counterweight, as known in the art. For example, without limitation, the position reference system 113 can be an encoder, sensor, or other system and can include velocity sensing, absolute position sensing, etc., as will be appreciated by those of skill in the art.

The controller 115 may be located, as shown, in a controller room 121 of the elevator shaft 117 and is configured to control the operation of the elevator system 101, and particularly the elevator car 103. It is to be appreciated that the controller 115 need not be in the controller room 121 but may be in the elevator shaft or other location in the elevator system. For example, the controller 115 may provide drive signals to the machine 111 to control the acceleration, deceleration, leveling, stopping, etc. of the elevator car 103. The controller 115 may also be configured to receive position signals from the position reference system 113 or any other desired position reference device. When moving up or down within the elevator shaft 117 along guide rail 109, the elevator car 103 may stop at one or more landings 125 as controlled by the controller 115. Although shown in a controller room 121, those of skill in the art will appreciate that the controller 115 can be located and/or configured in other locations or positions within the elevator system 101. In one embodiment, the controller 115 may be located remotely or in a distributed computing network (e.g., cloud computing architecture). The controller 115 may be implemented using a processor-based machine, such as a personal computer, server, distributed computing network, etc.

The machine 111 may include a motor or similar driving mechanism. In accordance with embodiments of the disclosure, the machine 111 is configured to include an electrically driven motor. The power supply for the motor is a variable speed drive, which may be commonly referred to as a drive. As understood by those skilled in the art, the drive is comprised of several electrical circuits such as an inverter, rectification stage, filtering, and control circuitry towards the purpose of controlling the motor. The machine 111 may include a traction sheave that imparts force to tension member 107 to move the elevator car 103 within elevator shaft 117.

The elevator system 101 also includes one or more elevator doors. The elevator door may be integrally attached to the elevator car 103 or the elevator door may be located on a landing 125 of the elevator system 101, or both. Embodiments disclosed herein may be applicable to both an elevator door integrally attached to the elevator car 103 or an elevator door located on a landing 125 of the elevator system 101, or both. The elevator door opens to allow passengers to enter and exit the elevator car 103.

Although shown and described with a roping system including tension member 107, elevator systems that employ other methods and mechanisms of moving an elevator car within an elevator shaft may employ embodiments of the present disclosure. For example, embodiments may be employed in ropeless elevator systems using a linear motor to impart motion to an elevator car. Embodiments may also be employed in ropeless elevator systems using a hydraulic lift to impart motion to an elevator car. Embodiments may also be employed in ropeless elevator systems using self-propelled elevator cars. FIG. 1 is merely a non-limiting example presented for illustrative and explanatory purposes.

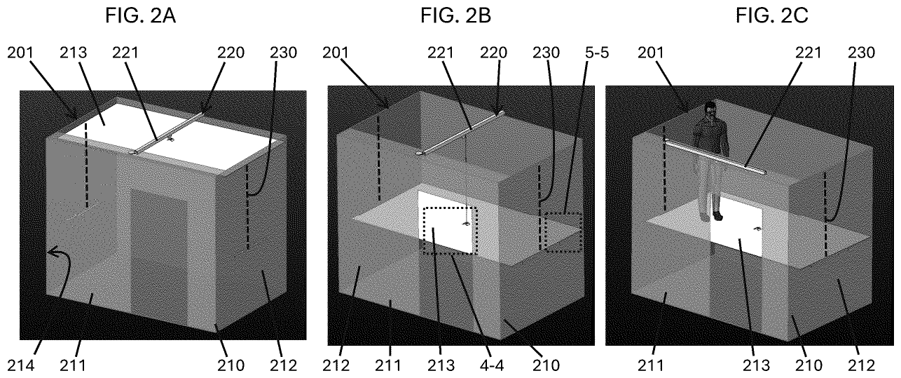

With continued reference to FIG. 1 and with additional reference to FIGS. 2A, 2B and 2C, an elevator car 201, such as the elevator car 103 of FIG. 1, is provided and includes a body 210 and an actuation system 220. The body 210 includes a floor 211, sidewalls 212 and a ceiling 213 as well as a frame 214 (see FIG. 2A). The ceiling 213 is movable relative to the sidewalls 212 to adjust a height thereof above the floor 211. The actuation system 220 includes various components 221 that are coupled with the ceiling 213. The components 221 can include or be provided as a winch or actuation element disposable to extend across the ceiling 213. The actuation system 220 is operable to raise and lower the ceiling 213 between a raised position as shown in FIG. 2A and a lowered position as shown in FIGS. 2B and 2C. With the ceiling 213 provided in the lowered position, the components 221 of the actuation system 220 can be moved to a side of the elevator car 201. An operator can climb onto the top of the ceiling 213 to conduct various inspection and maintenance operations.

In accordance with embodiments, the sidewalls 212 can be formed to define guide grooves 230 for guiding a raising and a lowering of the ceiling 213.

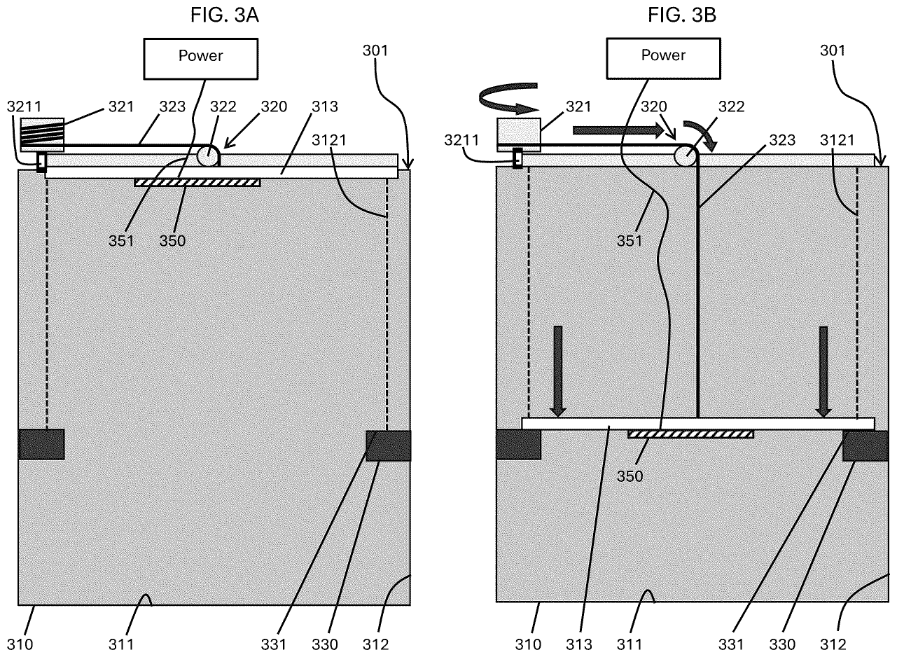

With continued reference to FIG. 1 and with additional reference to FIGS. 3A and 3B and FIGS. 4-6, an elevator car 301, such as the elevator car 103 of FIG. 1, is provided and includes a body 310 and a winch 320. The body 310 includes a floor 311, sidewalls 312 and a ceiling 313. The ceiling 313 is movable relative to the sidewalls 312 to adjust a height thereof relative to the floor 311. The winch 320 includes a spool 321, a brace 322 and a cable 323. The cable 323 is woundable on the spool 321, extendable around the brace 322 and attached to the ceiling 313. The spool 321 is operable to raise and lower the ceiling 313 between a raised position as shown in FIG. 3A and a lowered position as shown in FIG. 3B by winding and unwinding the cable 323 with respect to the spool 321. The sidewalls 312 can be formed to define guide grooves 3121 for guiding the raising and the lowering of the ceiling 313. The spool 321 can be formed to define an opening 3211 into which a tool for operating the spool 321 is insertable into the spool 321. The brace 322 is disposable across a middle of the ceiling 313 and is also movable to a side of the body 310 (see FIG. 2C). With the ceiling 313 provided in the lowered position as shown in FIG. 3B and with the brace 322 moved to a side of the body 310, an operator can climb onto the top of the ceiling 313 to conduct various inspection and maintenance operations.

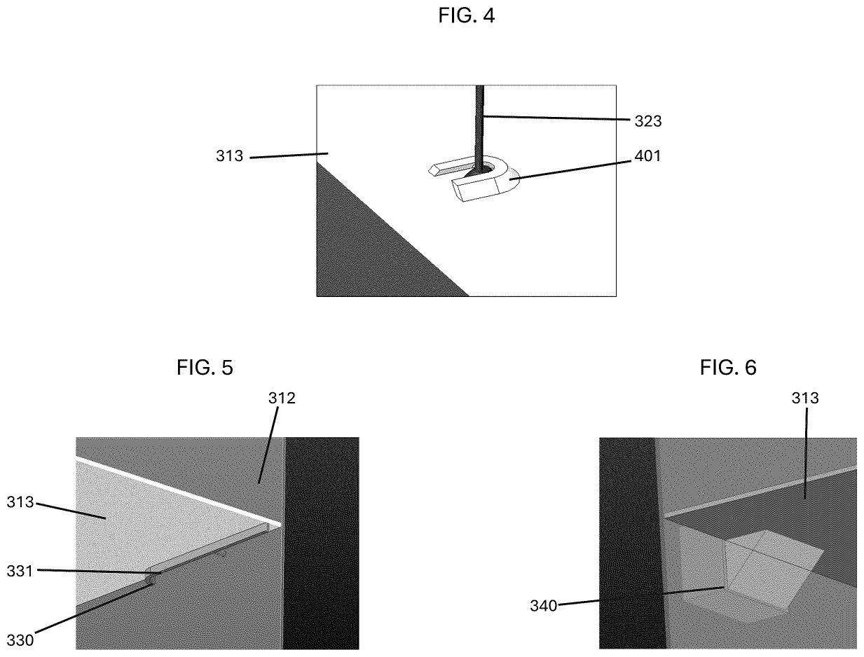

As shown in FIG. 4, the ceiling 313 can include an open-sided guard 401. The open-sided guard 401 can be disposable about a connection point 402 between the cable 323 and the ceiling 313. The open-sided guard 401 provides for formation of a relatively easy attachment and detachment of the cable 323 to and from the ceiling 313. As shown in FIGS. 3A, 3B and FIG. 5, the elevator car 301 can further include handrails 330 that are attached to the sidewalls 312 and platforms 331 that are disposable on the handrails 330 to support the ceiling 313 at a lowest point thereof. The platforms 331 can be disposed on the handrails 330 as needed by an operator and/or can be stowed on the ceiling 313 when not in use. As shown in FIG. 6, in an event the elevator car 301 does not have handrails 330, the elevator car 301 can include a foldable support 340. The foldable support 340 can be attached to or built into one or more of the sidewalls 312 as an alternative support for the ceiling 313. When folded, the foldable support 340 may not be visible so as to present an aesthetically pleasing appearance of the one or more of the sidewalls 312.

The ceiling 313 can include electronics 350, such as lights, speakers, fans, etc., and the elevator car 301 can further include wiring 351 with slack by which the electronics 350 are electrically connectable with a power source, such as grid or building power. The slack in the wiring 351 can allow the electronics 350 to continue to operate with power with the ceiling 313 in the raised or the lowered positions.

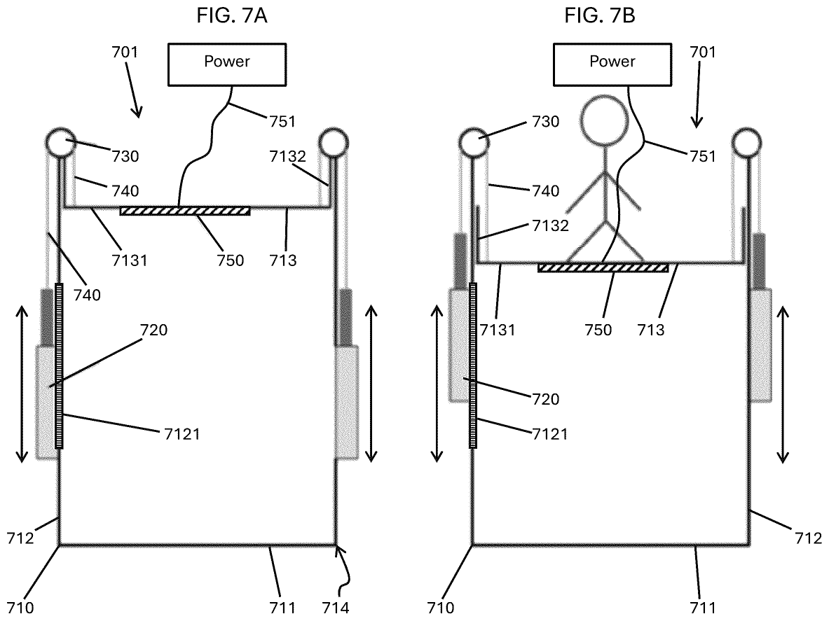

With continued reference to FIG. 1 and with additional reference to FIGS. 7A and 7B, an elevator car 701, such as the elevator car 103 of FIG. 1, is provided and includes a body 710, an actuator 720, a sheave 730 (in some embodiments) and a cable 740. The body 710 includes a floor 711, sidewalls 712 and a ceiling 713 as well as a frame 714. The ceiling 713 can have a bucket shape with a horizontal center portion 7131 and vertical sidewalls 7132 extending vertically upwardly from a perimeter of the horizontal center portion 7131 in order to provide additional space for an operator working on the ceiling 713. The ceiling 713 is movable relative to the sidewalls 712 to adjust a height of the ceiling 713 relative to the floor 711.

The actuator 720 can include or be provided as a linear actuator and is one of operable to be movable vertically or horizontally along an exterior of one of the sidewalls 712, operable to be movable vertically or horizontally through an interior of one of the sidewalls 712, operable to be movable vertically or horizontally within the body 710, operable to be movable vertically or horizontally along the frame 714 and operable to be movable along the ceiling 713.

For example, as shown in FIGS. 7A and 7B, the actuator 720 can be operable to move linearly along an exterior of one of the sidewalls 712 between a first height position associated with a raised position of the ceiling 713 as shown in FIG. 7A and a second height position associated with a lowered position of the ceiling 713 as shown in FIG. 7B. In order to increase an operability of the actuator 720, an exterior surface of the one of the sidewalls 712 can include a track 7121 along which the actuator 720 can be movable. The sheave 730 is disposed on the one of the sidewalls 712 and the cable 740 extends from the actuator 720, around the sheave 730 and to the ceiling 713 whereby the ceiling 713 is raised and lowered as the actuator 720 moves between the first and second positions.

As shown in FIGS. 7A and 7B, it is to be understood that the actuator 720, the sheave 730 (in some embodiments) and the cable 740 can be provided in respective pairs thereof on opposite sides of the body 710. In these or other cases, the pair of the actuators 720 can be operated in concert with one another to maintain a horizonal level of the ceiling 713.

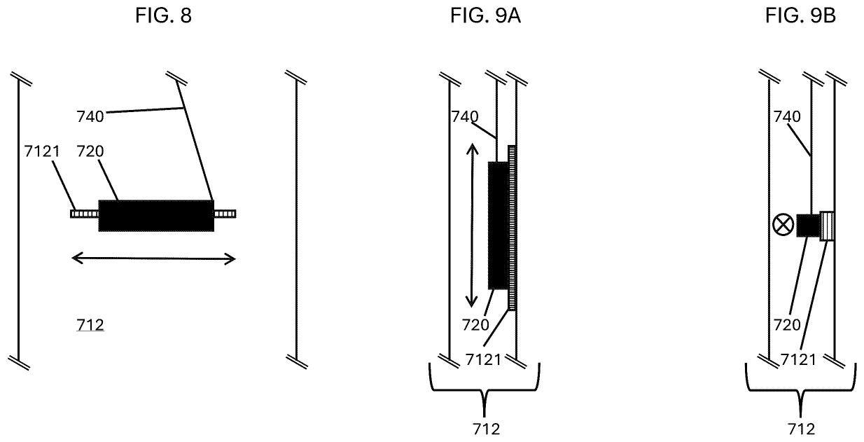

With reference to FIG. 8 and FIGS. 9A and 9B, the actuator 720 can include or be provided as a linear actuator and is one of operable to move horizontally along an exterior of one of the sidewalls 712 (see FIG. 8), operable to be movable vertically through an interior of one of the sidewalls 712 (see FIG. 9A) and operable to be movable horizontally through an interior of one of the sidewalls 712 (see FIG. 9B).

As noted above and as shown in FIGS. 4-6, the ceiling 713 can include an open-sided guard disposable about a connection point between the cable 740 and the ceiling 713 to provide for formation of a relatively easy attachment and detachment of the cable 740 to and from the ceiling 713 (see, e.g., the open-sided guard 401 of FIG. 4), the elevator car 701 can further include handrails attached to the sidewalls 712 and platforms that are disposable on the handrails to support the ceiling 713 at a lowest point thereof (see, e.g., the handrails 330 and the platforms 331 of FIG. 5) and the elevator car 701 can include a foldable support as an alternative support for the ceiling 713 (see, e.g., the foldable support 340 of FIG. 6) in an event the elevator car 701 does not have handrails.

The ceiling 713 can include electronics 750, such as lights, speakers, fans, etc., and the elevator car 701 can further include wiring 751 with slack by which the electronics 750 are electrically connectable with a power source, such as grid or building power. The slack in the wiring 751 can allow the electronics 750 to continue to operate with power with the ceiling 713 in the raised or the lowered positions.

Technical effects and benefits of the present disclosure are the provision of maintenance from inside car designs that provide for easily scalable solutions, that are easily deployable, that do not require an additional platform, that are cost-effective and that do not require special tools for installation or operation.

The corresponding structures, materials, acts and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the technical concepts in the form disclosed. Many modifications and variations will be apparent to those of ordinary skill in the art without departing from the scope and spirit of the disclosure. The embodiments were chosen and described in order to best explain the principles of the disclosure and the practical application and to enable others of ordinary skill in the art to understand the disclosure for various embodiments with various modifications as are suited to the particular use contemplated.

While the preferred embodiments to the disclosure have been described, it will be understood that those skilled in the art, both now and in the future, may make various improvements and enhancements which fall within the scope of the claims which follow. These claims should be construed to maintain the proper protection for the disclosure first described.

1. An elevator car, comprising:
a body comprising a floor, sidewalls and a ceiling movable relative to the sidewalls; and
an actuation system coupled with the ceiling and operable to raise and lower an entirety of the ceiling relative to the floor with an orientation of the ceiling relative to an orientation of the floor remaining constant at raised and lowered positions thereof.

2. The elevator car according to claim 1, wherein the actuation system comprises one of:
a winch comprising a spool and a cable, which is woundable on the spool and attached to the ceiling, the spool being operable to raise and lower the ceiling by winding and unwinding the cable; and
an actuator which is operable to move between first and second positions associated with raised and lowered positions of the ceiling, respectively, and a cable extending from the actuator and to the ceiling whereby the ceiling is raised and lowered as the actuator moves between the first and second positions.

3. An elevator car, comprising:
a body comprising a floor, sidewalls and a ceiling movable relative to the sidewalls; and
a winch comprising a spool and a cable, which is woundable on the spool and attached to the ceiling and a brace about which the cable extends between the spool and the ceiling,
the spool being operable to raise and lower an entirety of the ceiling relative to the floor and relative to the spool and the brace with an orientation of the ceiling remaining constant relative to an orientation of the floor at raised and lowered positions thereof by winding and unwinding the cable,
wherein the brace is disposed across a middle of the ceiling and the spool is disposed at a side of the ceiling such that the cable extends horizontally from the spool to the brace and vertically from the brace to the ceiling.

4. (canceled)

5. The elevator car according to claim 3, wherein the brace is movable to a side of the body.

6. The elevator car according to claim 3, wherein the ceiling comprises an open-sided guard disposable about a connection point between the cable and the ceiling.

7. The elevator car according to claim 3, wherein the spool is formed to define an opening into which a tool for operating the spool is insertable.

8. The elevator car according to claim 3, wherein the sidewalls are formed to define guide grooves for guiding a raising and a lowering of the ceiling.

9. The elevator car according to claim 3, further comprising:
handrails attached to the sidewalls; and
platforms disposable on the handrails to support the ceiling at a lowest point.

10. The elevator car according to claim 3, further comprising a foldable support.

11. The elevator car according to claim 3, wherein:
the ceiling comprises electronics, and
the elevator car further comprises wiring with slack by which the electronics are electrically connectable with a power source.

12. An elevator car, comprising:
a body comprising a floor, sidewalls and a ceiling movable relative to the sidewalls;
an actuator which is operable to move between first and second positions associated with raised and lowered positions of the ceiling, respectively; and
a cable extending from the actuator and to the ceiling whereby the ceiling is raised and lowered as the actuator moves between the first and second positions,
wherein the actuator is movable vertically or horizontally along an exterior of one of the sidewalls.

13. The elevator car according to claim 12, wherein the actuator and the cable are provided in pairs thereof on opposite sides of the body.

14. (canceled)

15. The elevator car according to claim 12, wherein the actuator comprises a linear actuator.

16. The elevator car according to claim 12, further comprising a track along which the actuator is movable.

17. The elevator car according to claim 12, wherein the ceiling comprises an open-sided guard disposable about a connection point between the cable and the ceiling.

18. The elevator car according to claim 12, further comprising:
handrails attached to the sidewalls; and
platforms disposable on the handrails to support the ceiling at a lowest point.

19. The elevator car according to claim 12, further comprising a foldable support.

20. The elevator car according to claim 12, wherein:
the ceiling comprises electronics, and
the elevator car further comprises wiring with slack by which the electronics are electrically connectable with a power source.
